(19) United States
(12) Patent Application Publication
(10) Pub. No.: US 2026/0148656 A1
(43) Pub. Date: May 28, 2026

(54) MOTION PLATFORM SYSTEM AND ASSOCIATED LINEAR ARM ACTUATOR

(71) Applicant: TRAXARA ROBOTICS INC., Montreal (CA)

(72) Inventor: Kamran Ghaffari Toiserkan, Montreal (CA)

(21) Appl. No.: 18/958,765

(22) Filed: Nov. 25, 2024

(51) Int. Cl. G09B 9/02

(52) U.S. Cl. CPC G09B 9/02

(57) ABSTRACT

The present disclosure concerns a motion platform system that includes a base and a platform movably supported on the base by a motion assembly having linear arm actuators. Each linear arm actuator includes a top joint and a bottom joint to respectively couple the platform and the base, and thereby defining a joint-to-joint axis between the top joint and the bottom joint. Each arm actuator is configured to reversibly extend along an axis of linear actuation to movably displace the platform relative to the base. In addition, the arm actuator is configured such that the axis of linear actuation is offset from the joint-to-joint axis. The offset arm actuator defines a rotation angle around the joint-to-joint axis. The joints are designed to impose a kinematic constraint around the joint-to-joint axis, thereby adjusting the rotation angle of the at least one linear arm actuator.

### TECHNICAL FIELD

The present disclosure generally relates to a multi-degree of freedom motion system, for example for simulation applications. In particular, the multi-degree of freedom motion system can be used to simulate motions of a vehicle, such an aircraft, a maritime vessel, or a land vehicle.

### BACKGROUND

A motion platform system generally includes a platform, actuator legs to hold and move the platform, and a grounded base to support the actuator legs. A cabin can be mounted on top of the platform to host a human pilot who experiences motions simulated by the system and optionally provides host inputs to the system directly or indirectly. Some of the simulated effects experienced by the pilot include acceleration, braking, turbulence, centrifugal forces, etc. As such, motion platform systems, also known as simulators, have found many applications including training and entertainment. A pilot's or driver's training can be performed in a safe, controlled space, and at relatively low cost compared to real-life training on aircraft, sea vessels, and land vehicles, characterized by high operational costs and where mistakes can be unforgiving.

The ability of a simulator to generate complex motions can be described in terms of degrees of freedom. If the motion simulator has six degrees-of-freedom (“6 DOF”), it includes three translational degrees of freedom (“tDOF”) and three rotational degrees of freedom (“rDOF”). In an aerospace context, the three rotational degrees of freedom are known as roll (rotation about an axis parallel to the direction of travel), pitch (rotation about a lateral axis perpendicular to the direction of travel), and yaw (rotation about a vertical axis perpendicular to both the direction of travel and the lateral axis). In a maritime context, the translational degrees of freedom are known as surge (movement in the direction of travel), sway (lateral movement, perpendicular to the direction of travel) and heave (vertical motion). Motion simulation systems that simulate 6 DOF carried out by six actuator legs are also known as hexapods, Stewart platforms or Gough-Stewart platforms.

Regardless of the number of degrees-of-freedom provided, many existing motion platform systems strive to achieve high range of motion and acceleration in each one of the degrees of freedom without compromising on other parameters such as range of motion, maximum payload, maximum acceleration and velocities, and an actuator topology that allows for a compact form factor. Some motion simulator platform designs are also non-symmetrical because of load balancing constraints that require actuators of varying lengths.

To satisfy the evolving requirements of end-users in different industries, existing motion platform systems have generally become more complex-both mechanically and in terms of controls-bulky and less modular, in order to meet the needs of specific fields (e.g., the field of flight training simulation) for increased realism and specialized functions. For example, for larger workspaces that require deeper platform movements in a given degree-of-freedom, some systems have elected the solution of providing longer actuator legs, resulting in a larger ground footprint and possibly a greater height of the system. Motion platforms have a finite workspace defined by the maximum excursions of the platform, which is in turn constrained by the limit of travel of the actuators. Besides floor space considerations, longer actuators have their own inherent pitfalls, such as an increased cost and a decreased mechanical stiffness. For example, longer actuator legs increase the bending moments applied to the shafts of the actuators'motors. Inversely, a solution that hinges on shorter actuator arm may result in conflicts between the envelopes of the individual linear actuators, thus introducing a risk of inter-collisions in the system workspace.

Considering the foregoing, and the ever-increasing requirements for performing motion simulators, there exists a need for a motion platform system that at least partially addresses the shortcomings discussed above.

### BRIEF SUMMARY

In accordance with a first general aspect, there is provided a motion platform system that includes a base and a platform movably supported on the base by a motion assembly having linear arm actuators. Each linear arm actuator includes a top joint and a bottom joint to respectively couple the platform and the base, and thereby defining a joint-to-joint axis between the top joint and the bottom joint. Each arm actuator is configured to reversibly extend along an axis of linear actuation to movably displace the platform relative to the base. In addition, the arm actuator is configured such that the axis of linear actuation is offset from the joint-to-joint axis. The arm actuator defines a rotation angle around the joint-to-joint axis. The arm actuator includes a kinematic chain between the top joint to the bottom joint that is configured to impose a kinematic constraint around the joint-to-joint axis, thereby adjusting the rotation angle of the at least one linear arm actuator.

According to one embodiment, the at least one linear arm actuator is configured such that the axis of linear actuation intersects with the joint-to-joint axis at one of the top joint and the bottom joint.

According to one embodiment, the at least one linear arm actuator is configured such that the axis of linear actuation and the joint-to-joint axis are non-intersecting with one another.

According to one embodiment, the at least one arm linear actuator is further configured such that the axis of linear actuation and the joint-to-joint axis are parallel to one another.

According to one embodiment, the at least one linear arm actuator comprises a first linear arm actuator and a second linear arm actuator. The first and second linear arm actuators respectively have a first rotation angle around a first joint-to-joint axis and a second rotation angle around a second joint-to-joint axis. The first and second linear arm actuators are separately coupled to the platform and the base. A respective kinematic chain of the first and second linear arm actuators is configured (e.g., constructed) to impose a respective kinematic constraint around the first and second joint-to-joint axes, thereby adjusting the first and second rotation angles to allow a cross-arrangement of the first and second linear arm actuators.

According to one embodiment, each first and second linear arm actuators further comprises a bracket portion interconnecting the linear actuating portion thereof and one of the top joint and the bottom joint. The linear actuating portion and the bracket portion define a free concave area therebetween. The first and second rotation angles of the first and second linear arm actuators are further adjusted via the respective kinematic constraints such that the free concave areas of the first and second linear arm actuators are adjacent to one another, thus allowing the cross-arrangement.

According to one embodiment, the linear actuating portions of the first and second linear arm actuators respectively have a first outermost elbow portion and a second outermost elbow portion with respect to the first and second joint-to-joint axes. The first rotation angle is further adjusted via the respective kinematic constraints such that the first outermost elbow portion is positioned distantly from a central vertical axis of the base. The second rotation angle is adjusted via the respective kinematic constraint such that the second outermost elbow portion is positioned proximately to the central vertical axis of the base, thus allowing the cross-arrangement.

According to one embodiment, the first and second rotation angles are preset via the respective kinematic constraints to maintain a minimum arm distance between the first linear arm actuator, the second linear arm actuator, and any other one of the plurality of linear arm actuators, depending on a range of configurations of the platform with respect to the base.

According to one embodiment, the first and second rotation angles are preset via the respective kinematic constraints to maintain a minimum base distance between the first linear arm actuator, the second linear arm actuator, and the base, depending on a range of configurations of the platform with respect to the base.

According to one embodiment, the first and second rotation angles are further adjusted via the respective kinematic constraints to maintain a minimum joint distance between mating faces of any one of the top joint and the bottom joint, depending on a range of configurations of the platform with respect to the base.

According to one embodiment, the second rotation angle of the second linear arm actuator is greater than the first rotation angle of the first linear arm actuator.

According to one embodiment, discrete platform connection points for the top joints of the plurality of linear arm actuators are concentrically distributed on a surface of the platform with respect to a central vertical axis of the platform. When the motion assembly is not being actuated, a first platform connection point for a top joint of the first linear arm actuator is shifted on the platform surface by one platform connection point with respect to a vertical axis of a bottom joint of said first linear arm actuator. A second platform connection point for a top joint of the second linear arm actuator is vertically aligned with the bottom joint of the first linear arm actuator.

According to one embodiment, the connection points of the top joints of the plurality of linear arm actuators are further radially equally distributed on the surface of the platform.

According to one embodiment, discrete connection points for the bottom joints of the plurality of linear arm actuators are concentrically and radially equally distributed on a top surface of the base with respect to the central vertical axis of the base.

According to one embodiment, the top joint and the bottom joint of the at least one linear arm actuator respectively comprise a universal joint and a spherical joint.

According to one embodiment, the top joint of the at least one linear arm actuator further comprises an angled wedge interposing the universal joint thereof and the surface of the platform. The angled wedge forms a wedge angle along a tangent direction with respect to a peripheral edge of the platform. A base of the spherical joint of the lower joint projecting from the upper surface of the base is tilted towards the central vertical axis of the base.

According to one embodiment, the plurality of linear actuators arms comprises at least eight linear arm actuators providing six degrees-of-freedom to the platform.

According to another general aspect, there is provided a motion platform system comprising: a base; and a platform movably supported on the base by a motion assembly. The motion assembly comprises a plurality of linear arm actuators. Each one of the plurality of linear arm actuators comprises an upper end coupled to the platform via a top joint, a lower end coupled to the base via a bottom joint, and a linear actuating portion. The linear actuating portion is provided between the upper end and the lower end, configured to reversibly extend along an axis of linear actuation to movably configure, at least partly, the platform relative to the base. The at least one linear arm actuator being configured such that the axis of linear actuation is offset from the joint-to-joint axis. The plurality of linear arm actuators comprises first and linear second arm actuators respectively having a first rotation angle around a first joint-to-joint axis and a second rotation angle around a second joint-to-joint axis. The first and second linear arm actuators are separately coupled to the upper platform and the base. A respective kinematic chain of the first and second linear arm actuators from a corresponding top joint to the bottom joint is configured to impose a respective kinematic constraint around the first and second joint-to-joint axes, thereby adjusting the first and second rotation angles to allow a cross-arrangement of the first and second arm actuators.

According to another general aspect, there is provided a linear arm actuator operably connectable to a platform and a base for a motion platform system. The linear arm actuator comprises: a first end operably mounted with a first joint configured to couple one of the platform and the base of the motion platform system, and a second end operably mounted with a second joint configured to couple the other one of the platform and the base of the motion platform system, thereby defining a joint-to-joint axis between the first joint and the second joint. The linear arm actuator also comprises a linear actuating portion provided between the first end and the second end, and configured to reversibly extend along an axis of linear actuation to space apart the first end and the second end. The linear arm actuator is configured such that the axis of linear actuation is offset from the joint-to-joint axis. At least one of the first and second joints is configurable to impose a kinematic constraint around the joint-to-joint axis to adjust a rotation angle of the linear arm actuator around the joint-to-joint axis.

### BRIEF DESCRIPTION OF DRAWINGS

The accompanying drawings illustrate an embodiment of the present invention and, together with the description, serve to explain the principles of the present disclosure.

FIG. 1 is an upper perspective view of a motion platform system, wherein the motion platform system includes a platform, a base, and a motion assembly having linear arm actuators, top joints and bottom joints, in accordance with an embodiment, and showing the motion platform system in a centered configuration, in which the platform is moved to a maximum heave and is centered with respect to the base;

FIG. 2 is an upper perspective view of the motion platform system of FIG. 1, showing the motion platform system in a configuration in which the platform is moved to a maximum yaw in a counter-clockwise direction from a top plan view;

FIG. 3 is an upper perspective view of the motion platform system of FIG. 1, showing the motion platform system in a configuration in which the platform is moved to a maximum yaw in a clockwise direction from a top plan view;

FIG. 4 is a top plan view of the motion platform system of FIG. 1, with the movable platform represented by dotted lines;

FIG. 5 is an upper perspective view of the motion platform system of FIG. 1, showing the motion platform system in a configuration in which the platform is tilted according to a maximum pitch;

FIG. 6 is a side elevation view of a first (outer) linear arm actuator of the linear arm actuators of FIG. 1, showing the first linear arm actuator operatively connected to a respective top joint and bottom joint, wherein a joint-to-joint axis and an axis of linear actuation are illustrated;

FIG. 7 is an enlarged view, partly sectioned, of the first linear arm actuator of FIG. 6, wherein an angular offset of the first linear arm actuator is illustrated;

FIG. 8 is an enlarged view, partly sectioned, of a second (inner) linear arm actuator of the linear arm actuators of FIG. 1, showing the second linear arm actuator operatively connected to a respective top joint, wherein a rotation angle of the second linear arm actuator is illustrated; and

FIG. 9 is a further enlarged view, partly sectioned, of the first linear arm actuator with the top joint thereof, wherein a wedge angle and supplementary angles of a universal joint along one rotational degree of freedom are illustrated.

It is understood that the drawings are for illustration purposes only and may not be to scale. The drawings are intended to depict only a typical embodiment according to the disclosure and therefore should not be considered as limiting.

### DETAILED DESCRIPTION

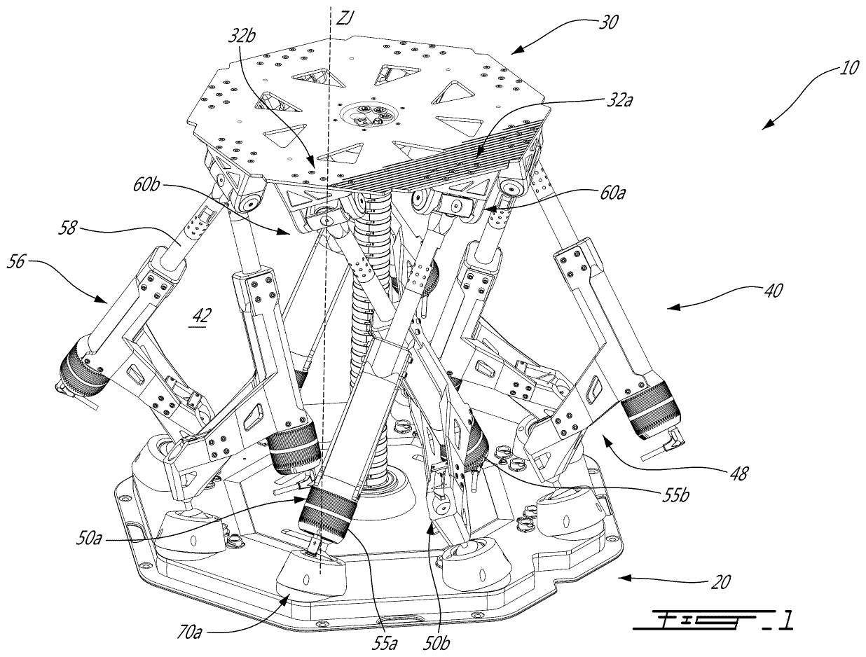

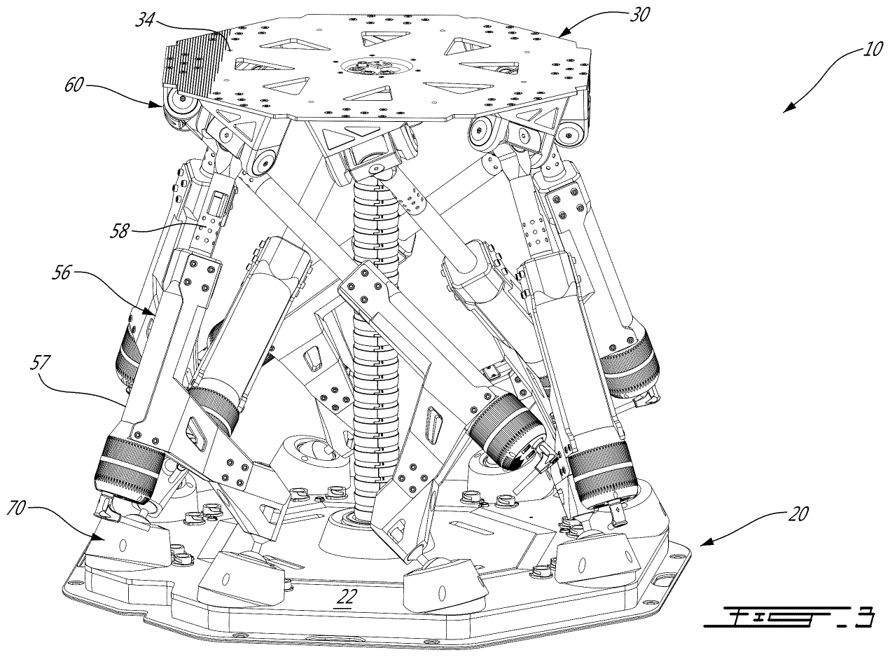

With reference to FIGS. 1 to 9, there is provided a motion platform system 10 that can simulate motions, for example motions requested by a host, in accordance with a non-limiting embodiment. The motion platform system 10 (also referred to as motion system) includes a base 20, and a movable platform 30 (also referred to as upper platform or moving plate) supported on the base 20 and driven by a motion assembly 40.

The number of degrees of freedom (“DOF”) and the workspace offered to the movable platform 30 depends on the configuration of the motion assembly that movably supports the platform 30 on the base 20. More specifically, the motion assembly 40 includes a plurality of linear arm actuators 50i (also referred to as arm actuator—i being the number of arm actuators, which are generally designated by reference sign 50 in the present description, and which include pairs of such arm actuators 50 designated with reference signs 50a and 50b) coupled to the base 20 and to the platform 30 that enables a desired movement of the platform 30 relative to the base 20.

The term “workspace” refers to the physical and operational space within which the motion platform 30 and any other moving part of the system 10 can move. It encompasses the range of motion, positions, orientations, and velocities that the platform can achieve while supporting an attached load, such as a cabin or a seat. Some of the moving parts of the motion system 10 that define the system workspace are not illustrated in FIGS. 1 to 9, such as cables.

The motion assembly 40 is implemented and/or configured to provide six degrees of freedom (“6 DOF”) to the motion platform 30 with respect to an orthogonal coordinate frame of reference (not illustrated).

According to an illustrative orthogonal frame of reference, the point of origin is the center of the base 20, the X-axis and the Y-axis substantially share a horizontal plane with the base 20, and the Z-axis extends in a bottom-top direction.

The terms “top”, “bottom”, “lower” and “upper” as used herein use the ground as a reference. For example, an element that is designated as being on “top” means that it is relatively further from the ground.

In this non-limiting embodiment, the motion platform system 10 includes eight linear arm actuators 50i offering 6 DOF to the platform 30. Depending on the desired number of DOFs and whether the platform is overactuated, other suitable number of linear arm actuators 50i may be used in other embodiments, for example as low as four and as many as twenty-four linear arm actuators are envisioned herein for the motion platform system 10.

Referring to FIGS. 1 to 5, the base 20 is structurally adapted to support the motion assembly 40 on a top surface thereof, in addition to the platform 30, and a pilot's cabin, or the like. In one mode of use, the base 20 is fixed or secured to the ground so as to substantially prevent any movement of the base 20 relative to the ground. In some non-limiting examples, the base 20 can be anchored to a cement or concrete floor according to the load specifications of the motion platform system 10, as will be known in the art. The top surface of the base 20 will generally face the platform 30 when the motion assembly 10 is in use.

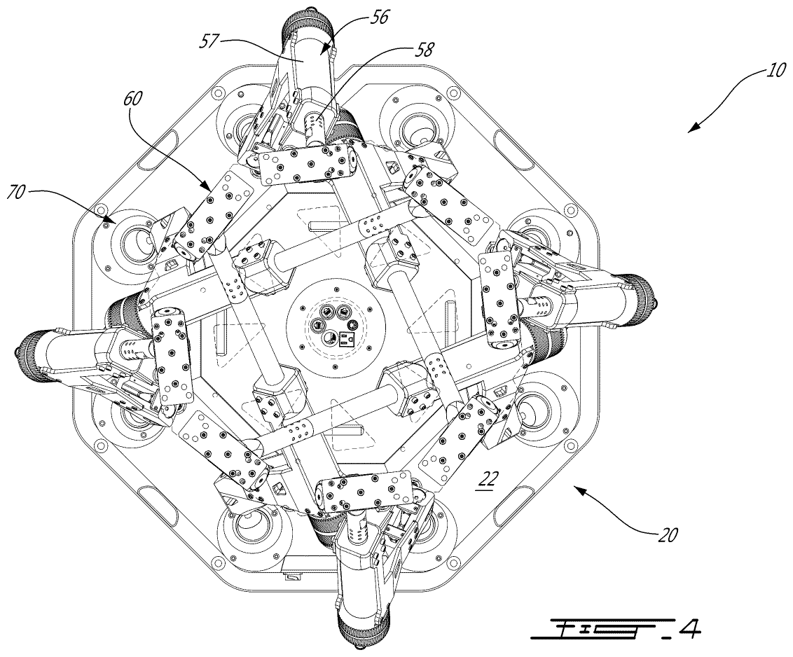

In this embodiment, the base 20 is also sized or dimensioned to accommodate eight linear arm actuators 50i distributed over the base 20 top surface 22 and has an octagonal shape when viewed from a top plan perspective (see FIG. 4). The arrangement that provides an “equal distribution” of the arm actuators 50i is explained further below. Other shapes are contemplated for the base 20 in other embodiments, such as but not limited to a triangular shape, a star shape, a rectangular shape, a square shape, a circular shape or a near-circular shape. In this embodiment, discrete connection points (i.e., connection interfaces) for bottom joints 70 of the arm actuators 50i are concentrically and radially equally distributed on the top surface 22 of the base 20 with respect to a central vertical axis of the base 20 (not illustrated).

In the embodiment shown, to enable the linear arm actuators 50i to couple to the base 20, each bottom joint 70 is made integral with the base 20, at least partly.

It will be appreciated that, in this embodiment, the concentric and equal radial distribution of the linear arm actuators 50i on or around the base 20 allows for a symmetric arrangement of the motion platform system 10 when assessed in a centered configuration in which the central axes (not illustrated) of the base 20 and the platform 30 are aligned (see the centered configuration of FIG. 1), as enabled by the characteristics of the motion assembly 40 explained in more detail below. A “symmetric” motion platform system refers to a system where the structure and motion capabilities are mirrored with reference to a vertical plane crossing the center axis of the base 20. It is understood that a symmetric motion platform is often desirable because it can lead to a more predictable and balanced behavior for the control systems.

The base 20 can be dimensioned to any suitable size to accept a correspondingly smaller or higher number of linear arm actuators 50i.

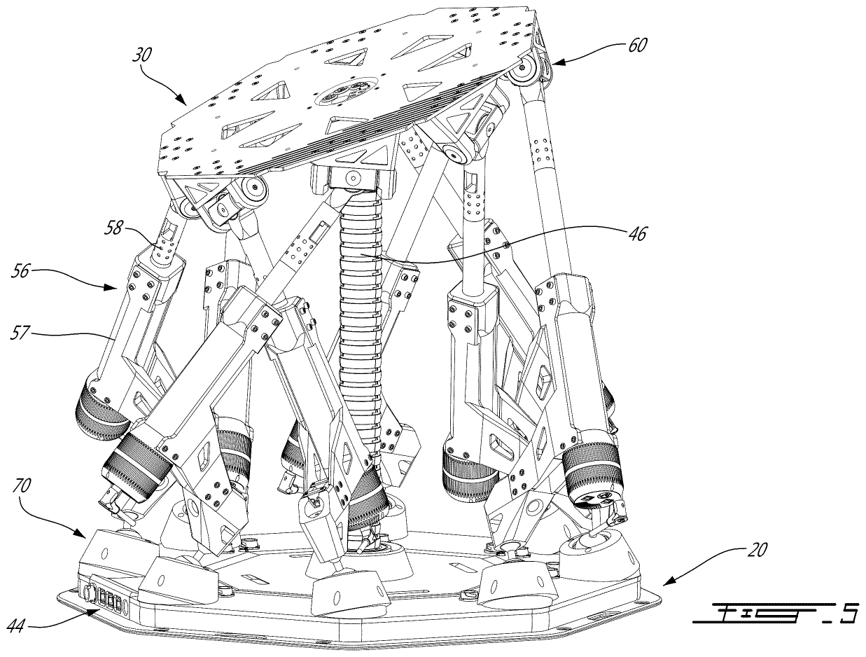

The base 20 can include a side surface extending downwardly from an edge of the top surface 22 of the base 20. In the embodiment shown, the octagon base 20 correspondingly presents eight side surfaces. To improve modularity of the motion system 10, the base 20 can also include a variety of access ports 44. As can be seen in FIG. 5, the access ports 44 can be disposed on a single side surface to provide a single connection point for external components. The access ports 44 can relate to a plurality of functionalities of the motion platform system 10, including, and without being limited to: a communication connection (e.g., Ethernet, USB, etc.) for the pilot host, a power supply connection for the host, power and data ports for onboard audio, visual, and control interfaces. Internal cables connected to the access ports 44 can come out about a center of the base 20 to reach the platform 30 above.

The platform 30 is a load-bearing structure that can support a cabin or any other type of framework adapted to host a pilot. In this embodiment, the platform 30 is shaped to define a planar plate which is adapted to connectedly receive the motion assembly 40 on a bottom surface thereof and to optionally attach a host cabin or other framework on a top surface thereof. As better shown in the top plan view of FIG. 4, in this embodiment the platform 30 has an octagonal shape similar to the octagonal shape of the base 20, but the platform 30 is smaller in comparison. The relative sizes of the platform 30 and the base 20 can vary from the embodiment shown.

The exemplary shape configurations provided as alternatives to the octagon shape of the base 20 can also be used as alternatives to the octagon shape of the platform 30 illustrated in FIGS. 1 to 5. As another alternative, the platform 30 can be embodied by a frame, and not a plate structure as shown.

To facilitate the attachment of the host cabin, for instance, rig attachment apertures 34 are defined in the platform 30 and distributed at regular intervals according to a topology suited to receive corresponding attachment means of the host cabin.

To allow the linear arm actuators 50i to be coupled with the platform 30, the platform 30 defines a series of clustered attachment apertures, the location thereof corresponding to discrete platform 30 connection points 32 (i.e., connection interfaces) adapted to connectedly receive top joints 60 of the motion assembly 40. The platform connection points 32 shown are concentrically and equally radially distributed on the (bottom) surface of the platform 30 with respect to a central vertical axis of the platform 30 (not illustrated) which coincides with the snorkel-like conduit 46 in the centered configuration of FIG. 1. The platform connection points 32 are more specifically disposed near a peripheral edge (i.e., outer periphery) of the platform 30. Each cluster of attachment apertures features seven apertures arranged in an offset grid pattern, but the cluster arrangement can be adapted to varying types of joints. The arrangement of the platform 30 connection points 32 illustrated in FIGS. 1 to 5 is similar to the arrangement of the bottom joints 70 connection points to the base 20, i.e., each follow a octagonal pattern.

In use, the position and orientation of the platform 30 depend on the configuration of the linear arm actuators 50i of the motion assembly 40. The position and orientation of the platform are directly determined by the linear extension and retraction of the arm actuators 50i. The motion assembly 40 is operatively connected to a motion system controller. The motion system controller will generally accept a platform input signal from the host computer. The platform input signal can include information on a desired position and/or motion of the platform 30 to be achieved while staying within the operational and performance limits of the motion platform system 10. Consequently, the motion assembly 40 is configured to generate an appropriate output signal for the actuator motor of each one of the linear actuators.

Turning to the linear arm actuators 50i of the motion assembly 40, each one of the plurality of linear arm actuators 50i is mechanically identical with the exception of the kinematic constraints which dictate each rotation angle θ, as explained further below. Although in the present embodiment, the kinematic constraints are imposed on the top joints 60, which do not distinguish the arm actuators 50i, and as such the arm actuators 50i themselves can be considered identical. To achieve a relatively compact design, each one of the linear arm actuators 50i is not configured identically, as will be explained in more detail below.

For the sake of simplicity, reference will be made to a singular linear actuator arm (“actuator arm”), unless suggested otherwise.

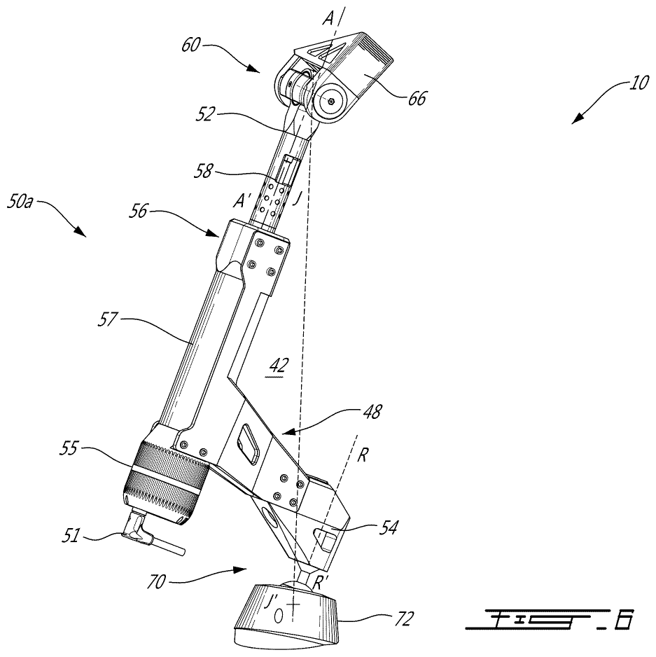

Referring more particularly to FIG. 6, the linear arm actuator 50i includes an upper end region 52 (i.e., a first end) and a lower end region 54 (i.e., a second end). The upper end region 52 can be coupled to the platform 30 via a top joint 60. The lower end region 54 can be coupled to the base 20 via a bottom joint 70. As such, the top joint 60 and the bottom joints 70 define a joint-to-joint axis JJ′ (see FIG. 6) therebetween. More particularly, the joint-to-joint axis JJ′ extends through a center of rotation (CoR) of each one of the top and bottom joints 60, 70. It is understood that some joints, whether spherical joints or universal joints, can be considered to rotate around a fixed point (illustrated as crosses in FIG. 6). The center of rotation of a joint can be the center around which the linear arm actuator (e.g., the shaft thereof) bends in multiple directions depending on the number of rotational degrees of freedom enabled by the joint. The manner by which the center of rotation is applied to the illustrated embodiments of the top and bottom joints 60, 70 is explained further below.

The linear arm actuators 50i of the motion assembly 40 can be configured in different ways to provide a relatively compact design. The linear arm actuators 50i can include a linear actuating portion 56 configured to reversibly extend along an axis of linear actuation AA′ (see FIGS. 6 to 8). By means of coordinated extension or contraction of the linear actuating portion 56 of each arm actuator 50, the platform 30 is correspondingly moved according to one or more selected DOFs relative to the base 20.

Alternatively to the exemplary arm actuators 50 shown in FIGS. 1 to 9 which each include a single linear actuating portion 56, the arm actuator can include a plurality of constituent linear actuating portions 56 that are configured to collectively act as a linear actuating portion for an alternative arm actuator to provide the same actuating function. For example, two constituent linear actuating portions can be arranged in parallel or in series. The person of ordinary skill in the art would understand to suitably adapt the multi-actuating arm actuator to obtain a movement suitable for a motion platform system, and to arrange other connected elements (e.g., joints, bracket portion) accordingly.

In this embodiment, the linear actuating portion 56 includes an electromechanical motor and an actuator that can extend about 50% to 60% starting from its contracted length. See FIGS. 1 and 6 respectively for examples of a fully extended configuration and a fully contracted configuration of the linear arm actuators 50i. It will be readily appreciated that any other suitable actuator may be used in other non-limiting embodiments, such as but not limited to stroke actuators. Hydraulic actuators, pneumatic actuators, electromagnetic actuators, and any other suitable means to provide linear actuation are contemplated herein. The electromechanical actuator shown includes, among others, a motor 55 and a shaft 58 at least partially movably enclosed in a housing portion 57. A tip of the shaft 58 defines the upper end 52 of the linear arm actuator 50. The shaft 58 can travel inwardly or outwardly from the housing 57 portion along the axis of linear actuation (AA′) to allow the extension or contraction of the linear actuating portion 56 and thus the linear arm actuators 50i, which in turn moves the top joint 60 and bottom joints 70 in relation to each other. The linear actuating portion 56 shown also includes an elbow portion 55 provided at an opposite end of the housing 57 portion with respect to the shaft 58. The reference numeral of the elbow portion 55 corresponds to the reference numeral of the electromechanical actuator motor 55 in this embodiment. The electromechanical linear actuating portion 56 further includes a power supply connector 51 protruding from the elbow portion 55 (see FIG. 6). The power supply connector can be connected to a cable (not illustrated) that interconnects the linear actuating portion 56 to external components, like a power supply.

The axis of linear actuation AA′ is offset from the joint-to-joint axis JJ′ of the linear arm actuator 50. In other words, the axis of linear actuation AA′ of the linear arm actuators 50i, which is defined by the linear actuating portion 56, and more specifically by an extension-retraction axis of the shaft 58, is not colinear with the joint-to-joint axis JJ', which is defined by the joints at the extremities of the linear arm actuators 50i.

With reference to FIG. 6, the linear arm actuator 50i has an axis of linear actuation AA′ that is offset relative to the joint-to-joint axis JJ'. More particularly, the linear arm actuators 50i are configured such that the axis of linear actuation AA′ intersects with the top joint 60 but not with the bottom joint 70, as further described below.

To implement the offset axis of linear actuation AA′ with respect to the joint-to-joint axis JJ′, the linear arm actuators 50i further include a bracket portion 48. The bracket portion 48 is configured to interconnect and interpose the linear actuating portion 56 and the bottom joint 70. By interposing the linear actuating portion 56 and the bottom joint 70 by a distance, the bracket portion 48 spaces apart the axis of linear actuation AA′ and the joint-to-joint axis JJ′, thus creating the offset axes.

The term “bracket portion” as used herein, and more particularly the term “bracket”, is to be understood as any suitable intermediate structural component for fixing one part (e.g., a joint) to another larger part (e.g., the linear actuating portion 56 of the arm actuator 50), unless specified otherwise in relation to an embodiment.

The resulting space defined between the linear actuating portion 56 and the bracket portion 48 corresponds to a free concave area 42. The free concave area 42 affects the potential excursion of the actuator arm 50 and can be exploited by pairing neighbouring actuator arms 50, as explained below.

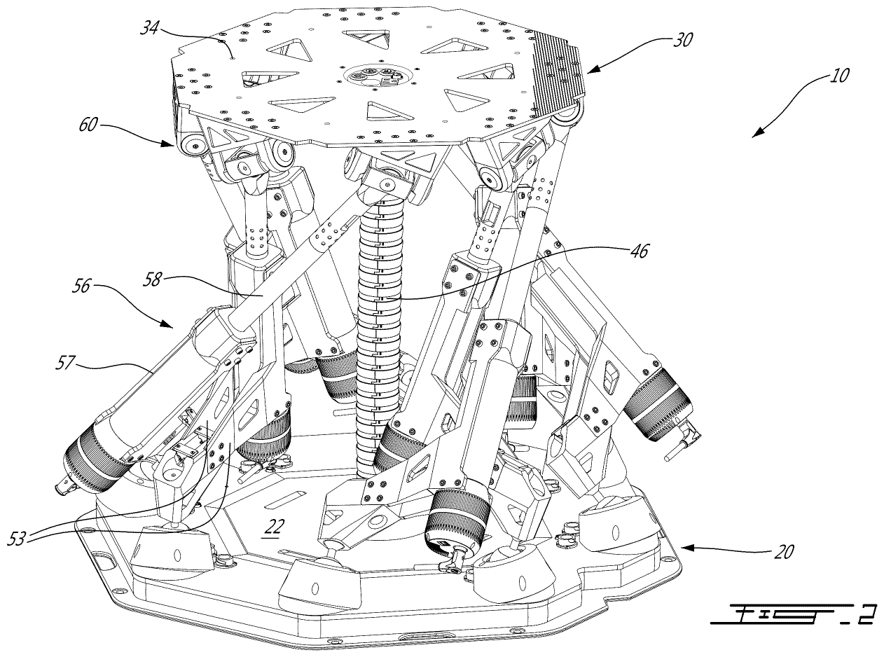

The bracket portion 48 implemented in the embodiment of FIGS. 1 to 9 extends from the housing and is fixedly connected to the bottom joint 70. The bracket portion 48 includes two plates 53 (see FIG. 2) that are fixedly connected to the linear actuating portion 56 at one end thereof, and the bottom joint 70 at an opposite end thereof (i.e., the lower end 54 of the arm actuator 50). The two plates are substantially parallel and taper towards the bottom joint 70. The plates 53 are fixed to the linear actuating portion 56 and to the bottom joint 70 via bolts. In other embodiments, the bracket portion 48 can be implemented in any other suitable manner. For example, the bracket portion 48 can include a gusset bracket, such that one edge of the gusset bracket is fixed to the joint 70 and the other perpendicular edge is connected to the linear actuating portion 56.

In the embodiment shown, the bracket portion 48 is fixed to the housing 57 portion of the linear actuating portion 56, such as to extend from an end of the housing 57 positioned adjacent the elbow portion 55. In alternative embodiments, the bracket portion 48 is connected to another segment of the housing 57, for example to a middle segment of the housing 57, in which case the axis of linear actuation AA′ is still offset from the joint-to-joint axis JJ′. Any other suitable means of connecting the bracket portion 48 to the housing 57 may be used in other non-limiting embodiments.

In such an embodiment having offset axes, the linear arm actuators 50i can be generally characterized as having a L-shape.

In the embodiment shown, and as previously explained in regard to the linear arm actuators 50i, the upper end 52 is coupled to the platform 30 and the lower end 54 is coupled to the base 20. According to another configuration (not shown), the arm actuator 50i shown can be inverted, such that the upper end 52 becomes coupled to the bottom joint 70 and the lower end 54 becomes coupled to the top joint 60. According to this alternative configuration, the bracket portion 48 is positioned proximally to the platform 30. It will be understood that the relative sizes of the bracket portion 48 and the linear actuating portion 56 can be adapted for an inverted actuator arm embodiment.

As previously explained in relation to the present embodiment, the linear arm actuators 50i can be adapted such that the axis of linear actuation JJ′ intersects with the joint-to-joint axis JJ′ at the top joint 60. It is understood that the axis of linear actuation AA′ would intersect the bottom joint 70, instead of the top joint 60 as shown, in the embodiment wherein the arm actuator is inverted.

According to another alternative embodiment (not shown), the linear arm actuator 50 can be adapted such that the axis of linear actuation AA′ intersects with the joint-to-joint axis JJ′, but not at one of the top joint 60 and the bottom joint 70. To implement such an alternative embodiment, a Z-shape arm actuator, a serriform arm actuator, or the like, are contemplated herein. For example, in one embodiment, a serriform linear arm actuator can include a first section that substantially corresponds to the L-shape arm actuator 50 shown in the embodiment of FIGS. 1 to 9, and a second consecutive section extending from the first section that also is L-shaped and that does not include a linear actuator, resulting in a serriform linear arm actuator. According to the serriform actuator, the axis of linear actuation AA′ intersects the joint-to-joint axis JJ′ somewhere between the top and bottom joints 60, 70.

According to alternative embodiments (not shown), a linear arm actuator is instead configured such that the axis of linear actuation AA′ and the joint-to-joint axis JJ′ are non-intersecting with one another. More specifically, the linear actuator can be further configured such that the axis of linear actuation AA′ and the joint-to-joint axis JJ′ are parallel to one another. To implement such an alternative embodiment, a crenellated arm actuator is envisioned. A crenellated arm shape can include a linear actuating portion 56 provided in a segment parallel to the joint-to-joint axis JJ′, and also include other segments perpendicular thereto used to distance the parallel linear actuating portion 56 from the joint-to-joint axis JJ′. The crenels of the crenellated arm actuator can correspond to the free concave areas 42 of the illustrated embodiment of the arm actuator 50. As a result, the axis of linear actuation AA′ is parallel to the joint-to-joint axis JJ′.

It is understood that in the alternative embodiments including intersecting or non-intersecting axes of linear actuation AA′ and joint-to-joint JJ′, every portion of the alternative arm actuators extends substantially along a same plane shared with the joint-to-joint axis JJ′. It is also envisioned herein that the linear actuation portion is oriented to extend obliquely with respect to the bracket portion 48, and thus extend out-of-plane from the joint-to-joint axis JJ′.

The motion assembly 40 can also implement a select few of the linear arm actuators 50 previously described in combination with other types of arm actuators known in the art.

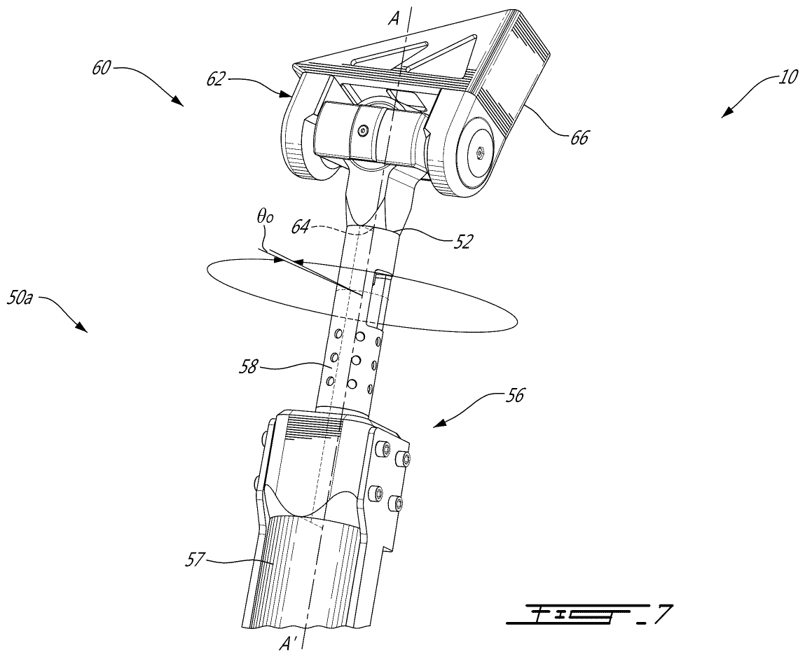

Each one of the linear arm actuators 50i may be operatively connected to one or more passive joint to couple the platform 30 or the base 20. Referring more particularly to FIG. 7, the top joint 60 coupling the linear arm actuator 50 to the platform 30 can include a passive universal joint 62 (offering 2 rDOF) and a passive pivot joint 64, the latter being locked (i.e., kinematically constrained) at the level of the upper end 52 section, resulting in 2 rDOF being used for the top joint 60, as further described below. Referring to FIG. 6, the bottom joint 70 can include a passive spherical joint 72 that couples the linear arm actuator 50 to the base 20, and which can grant 3 rDOF, two of which are effectively being used because of said kinematic constraint locking the rDOF around the joint-to-joint axis JJ′.

In an alternative embodiment (not shown), the top joint 60 does not include the passive pivot joint 64. Instead, the shaft 58 of the linear actuating portion 56 is merged, or otherwise made integral, with universal joint 62 of the top joint 60, for instance at the level of the upper end 52 section of the arm actuator 50. It is understood that the linear actuating portion 56 and the top joint 60 can be positioned around the joint-to-joint axis JJ′ relative to each other to create an angular offset therebetween (see below the description of the rotation angles θo, θe). The linear actuating portion 56 and the top joint 60 can be made integral during assembly.

With the necessary adjustments, different arrangements for the joints can be provided on the condition that the joints selected offer both suitable support and the required rotation DOFs to orient the arm actuator as the platform 30 moves in the workspace. For example, it is envisioned an embodiment (not shown) that provides different joint types, and different combinations of joint types. For example, and without being limitative, both the top and bottom joints 60, 70 can include a universal joint 62, instead of only the top joint 60. Furthermore, different types of joints can be included to the system 10, or incorporated into the linear arm actuator 50, that together provide the needed rDOF.

In the case of the spherical joint 72 having a socket and a ball pivotably housed in the socket, a geometrical center of the spherical ball can be considered the center of rotation of the bottom joint 70 for the purpose of delimiting the joint-to-joint axis JJ′.

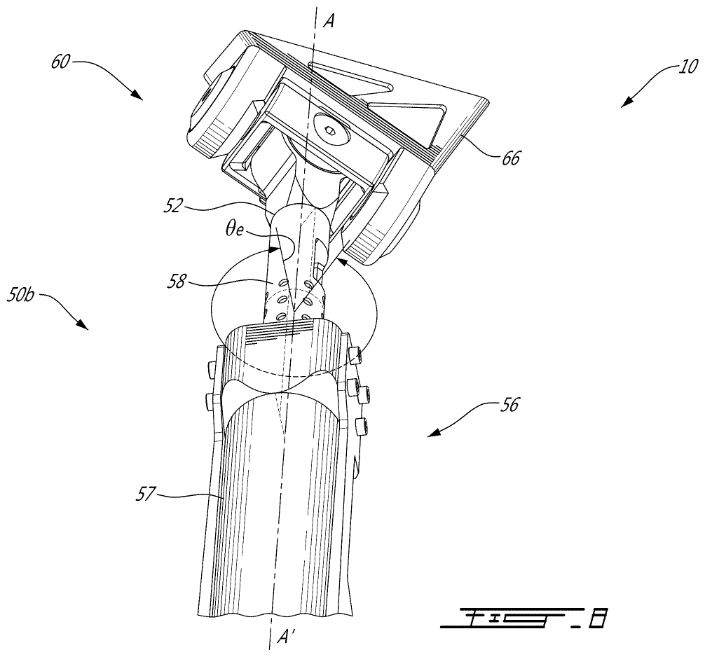

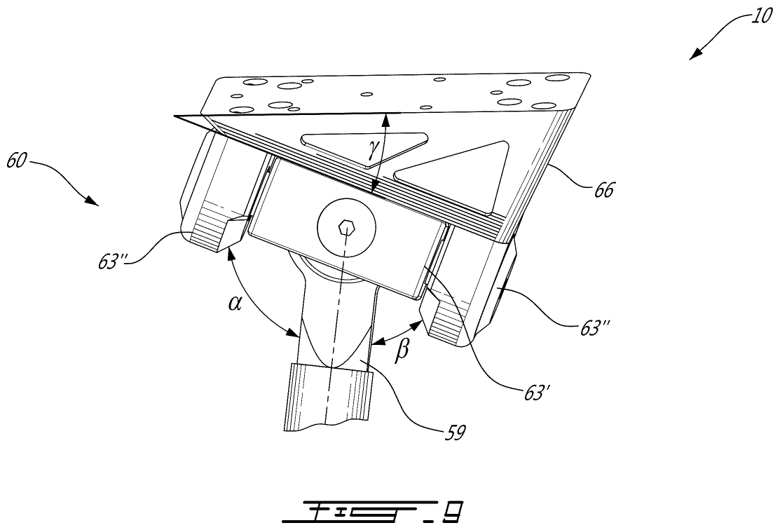

In the case of the top joint 60, one pivot joint exists (not visible) that locks the shaft 58, and thus the linear arm actuators 50i, around the axis of linear actuation AA′, thereby removing one rDOF at the interface between the shaft 58 and the upper joint 60 (i.e., at the upper end section 52 of the arm actuator 50). Referring to FIGS. 7 and 8, above the upper end 52 section, the top joint 60 further includes the universal joint 62 composed of: a block 63′ that pins an extension 59 of the shaft 58 to grant one rDOF to the joint 60, and a two-part yoke 63″ pivotably connected to each lateral side of the block to grant one additional rDOF to the joint 60 (see FIG. 9). Referring to FIG. 9, the rDOF provided by the pinned block can be measured by angles α and β defined between respective yoke parts and the axis of linear actuation AA′. The supplementary angles α and β define a joint range. The intersection of the axis of rotation of the block and the axis of rotation of the yokes can be considered the center of rotation of the top joint 60, as indicated by the end of the dotted axis AA′ for the purpose of delimiting the joint-to-joint axis JJ′.

To provide redundancy to the motion assembly 40, for instance to reduce joint resistance that may be caused by undesirable joint friction, the linear arm actuator 50 may be fitted with a redundant joint (i.e., an intermediate joint). As shown in FIG. 6, the bracket portion 48 is pivotably connected to the bottom joint 70 around a revolute axis RR′ via a revolute joint (not visible) at the lower end 54 of the arm 50. More specifically, the bracket portion 48 forms a planar section adapted to slidably engage a corresponding planar section of the bottom joint 70, which together form a planar sliding interface. The bottom joint 70 includes the spherical joint 72 at the lower end 54 section thereof. The revolute joint connecting the bracket portion 48 and the spherical joint 72 does not introduce a new rDOF to the arm actuator 50 as its revolute axis RR′ coincides with one of the three rDOF offered by the spherical joint 72. If the relevant rDOF of the spherical joint 72 is negatively affected for any reason (e.g., high loads creating undue friction in the spherical joint 72, lack of lubrification, etc.), the redundant joint can rotate around the affected rDOF, thus avoiding or limiting undesirable torsional forces on the linear actuating arm 50 in motion.

The top joint 60 and the lower joint 70 can be directly or indirectly fixed to the platform 30 and the base 20 respectively or, as shown in the embodiment of FIGS. 1 to 9, the top and bottom joints 60, 70 can be respectively interposed to the platform 30 and base 20 by an angled wedge 66 and a tilted pivot base. As shown, the angled wedge 66 forms a wedge angle γ (FIG. 9) extending along or parallel to a tangent direction with respect to a peripheral edge of the platform 30. For instance, the octagon platform 30 illustrated has eight sides, and each platform 30 side defines a tangent line there along.

Considering that the linear arm actuator 50 top and bottom joints 60, 70 together provide a rDOF around the joint-to-joint axis JJ′, the arm actuator 50 is by default free to rotate around its joint-to-joint axis JJ′ according to a rotation angle θ when the motion platform system 10 is actuated. It is understood that each rotation angle θo, θe illustrated in FIGS. 7 and 8 is a substitute equivalent to an actual rotation angle around the joint-to-joint axis JJ′. The rotation angle θ can be more convenient to measure around the upper end section 52 as a proxy to the actual rotation angle around the joint-to-joint axis JJ′. The rotation angle θ can be measured with respect to any suitable fixed reference, for example the block pivot axis of the universal joint 62 of the top joint 60.

To prevent inter collisions between the arm actuators 50, the arm actuators 50 and the base 20, and any critical component of the system 10, a kinematic constraint is imposed around the joint-to-joint axis JJ′ of each arm actuator 50. Also, because the described linear arm actuators 50 are asymmetrical with respect to their joint-to-joint axis JJ′ (i.e., the linear arm actuators 50 of FIGS. 1 to 6 are void of rotational symmetry), an opportunity exists to optimize their collective excursion topology of the motion assembly 40 via their rotation angles θ, not to merely avoid clashing, but to obtain a relatively compact motion assembly 40 in all configurations of the workspace. In any case, a preexisting knowledge of the rotation angles θ of the arms 50 around their respective joint-to-joint axis JJ′ is necessary to assess the vector forces applied to the platform 30 and thus plan general system 10 kinematics.

Kinematic constraints can be understood as any physical hard stops provided to limit or restrict rotational movement of the linear arm actuators 50i. Any suitable means to impose a kinematic constraint around the joint-to-joint axis JJ′ is contemplated herein, such as external linkages attached to the arm 50 and the base 20 to restrict rotation thereof, elastic elements to restrict the rotation while providing some leeway, magnetic constraints to repel the arm actuator 50 when reaching a critical angular orientation, and control system constraints operatively connected to a motor associated to an arm actuator joint, and any combinations thereof.

In the non-limitative illustrated embodiment, the kinematic constraint is imposed at the level of one of the joints, namely the top joint 60, of the motion assembly 40 as explained herein. In other embodiments (not shown), a kinematic constraint can be suitably imposed to other parts or segments of a kinematic chain of a given arm actuator 50 of the motion assembly 40. It will be understood that the series of rigid bodies or segments of the motion assembly 40 (e.g., the linear actuating portion 56, the bracket portion 48) that are linked with linkage means (e.g., the top joint 60, the bottom joint 70) constitutes the kinematic chain. In other words, a kinematic chain of the linear arm actuator 50 can exist between the top joint 60 to the bottom joint 70, including all parts and any potential joints in between.

In the embodiment provided, the kinematic constraints are applied directly to the top joint 60 of the motion assembly 40. More specifically, a kinematic constraint is imposed to the top joint 60, and even more specifically to the pivot joint 64 of the top joint 60 at the upper end 52 section of the arm actuator 50. According to one assembly method, the kinematic constraint is imposed during assembly by locking the pivot joint 64 at the upper end 52 section which will remain fixed during the operation of the motion platform assembly 10. Note that the kinematic constraint varies from one actuator arm 50a, 50b to the next of each pair in the embodiment shown. According to an alternative embodiment, the kinematic constraint can be applied to the bottom joint 70, including the redundant revolute joint 74.

With reference to FIGS. 1 to 5, the eight linear arm actuators 50 are grouped in four pairs. For the purpose of this disclosure, each one of the pairs has a first linear arm actuator 50a (i.e., outer or odd linear arm actuator) and a second linear arm actuator 50b (i.e., inner or even linear arm actuator). For the sake of simplicity, only one pair is annotated with numeral signs 50a, 50b in FIG. 1. Each pair thus described has an identical interconnection pattern, except for their respective connection locations to the platform 30 and the base 20.

The first and second linear arm actuators 50a, 50b respectively have a first rotation angle θo around a first joint-to-joint axis, and a second rotation angle θe around a second joint-to-joint axis. Each top joint 60 of the first and second linear arm actuators 50a, 50b is configured to impose a respective kinematic constraint around the first and second joint-to-joint axes, thereby adjusting the first and second rotation angles into fixed first and second rotation angles θo, θe to allow a cross-arrangement of the first and second linear arm actuators 50a, 50b.

It will be understood that the term “rotation angle” as used herein is not to be limited to an offset angle around the joint-to-joint axis JJ′ enabled by a pivot joint (e.g., pivot joint 64), as illustrated in the embodiment of FIGS. 1 to 9. As previously explained, the offset rotation angle of any one of the arm actuators 50 can be enabled by a linear arm actuator 50 that is merged-or otherwise made integral - with the top joint 60 to operably mount therewith. In other words, the kinematic constraint around the joint-to-joint axis JJ′ imposing the rotation angle θ can be an intrinsic structure of the motion assembly 40 which can be implemented during assembly of the motion system 10, for instance.

According to the embodiment, the first and second linear arm actuators are separately coupled to the platform 30 and the base 20, as opposed to shared joints or nexuses as is commonly found in the art, such as U.S. Pat. Publication U.S. Pat. No. 3,577,659A. If the first and second arm actuators 50a, 50b either shared a joint or a joint location, a cross-arrangement would not be possible or at least would not be practical. The separated connections configuration also contributes to a more decoupled system.

The cross-arrangement may manifest itself differently depending on the embodiment, as explained below. In every embodiment, the cross-arrangement features the first linear actuator 50a and the second linear actuator 50b of each pair being interconnected as explained herein.

As previously explained, in the embodiment of FIGS. 1 to 9, the platform 30 has equally distributed discrete platform connection points 32 (i.e., attachment points) for the top joints 60 with respect to the central vertical axis of the platform 30. When the motion assembly 40 is not actuated, except for a heave motion (one tDOF) as shown in FIG. 1 (e.g., when the central vertical axes of the platform 30 and the base 20 are aligned), a first platform 30 connection point 32a for a top joint 60a of the first arm actuator 50a is shifted on the bottom surface of the platform 30 by one discrete platform connection point 32 with respect to a vertical axis ZJ of a bottom joint 70a of said first arm actuator 50a. Moreover, a second platform connection point 32b for a top joint 60b of the second arm actuator 50b is vertically aligned with the bottom joint 70a of the first arm actuator 50a. The arm actuators 50a, 50b of each pair and thus cross-arranged.

As previously explained, each arm actuator 50, including the first and second actuators 50a, 50b of a pair, includes a free concave area 42. In the embodiment, the first and second rotation angles θo, θe of the first and second arm actuators 50a, 50b are adjusted via the respective kinematic constraints such that the free concave areas 42 of the arms 50a, 50b are adjacent to one another, thus allowing the cross-arrangement. In such a configuration, the first and second actuator arms 50a, 50b of a pair can be described as oppositely oriented to one another. The term “adjacent” as used to describe the spatial relationship between the free concave areas 42 can be understood to mean that the free concave areas 42 of the first and second arm actuators 50a, 50b overlap in at least one configuration of the motion platform system 10 and/or that they remain proximate in other configurations.

Not only are the kinematic constraints of each pair imposed in such as way to adjacently position the free concave areas 42 of the first and second arm actuators 50a, 50b, but the arm actuators represented in FIGS. 1 to 8 are more precisely oriented around their respective joint-to-joint axis JJ′ such that one arm actuator 50a generally protrudes outwardly with respect to a central vertical axis of the base 20 (not illustrated), and the other arm actuator 50b protrudes inwardly. In other terms, each of the linear arm actuators 50 has an outermost elbow portion 55. The elbow portion 55 is designated as “outermost” because it constitutes a segment of the arm actuator 50 that is orthogonally the furthest from the joint-to-joint axis JJ′. The outermost elbow portion 55 can be understood as also including a supply connector.

Returning to the pair grouping illustrated, the first and second linear arm actuators 50a, 50b respectively have a first and a second outermost elbow portion 55a, 55b with respect to their respective first and second joint-to-joint axes. Accordingly, the first rotation angle θo is adjusted via a respective kinematic constraint such that the first outermost elbow portion 55a is positioned distantly from the central vertical axis of the base 20, and wherein the second rotation angle θe is adjusted via a respective kinematic constraint such that the second outermost elbow portion 55b is positioned proximately to said central vertical axis, thus allowing the cross-arrangement. Again, in such configuration, the first and second actuator arms 50a, 50b of a pair can be described as oppositely oriented to one another. Moreover, it will be appreciated that this cross-arrangement of each pair substantially and generally orients the arm actuators 50 along a radial direction that provides more room between neighbouring pairs, thereby providing more space for the actuator arms 50 to adjust their angular position depending on a platform position 30.

The disclosure has thus far described means to adjust each linear actuator arm 50 through kinematic constraints to obtain a cross-arrangement (e.g., crossed attachment points, and oppositely oriented arms). This disclosure goes further in terms of optimization of the rotation angle θ of the offset arm actuators 50. It will be understood that the offset rotation angle θ affects the positioning of each arm actuator 50 around its joint-to-joint axis JJ′ at different platform configurations. The positioning of the actuator arm 50, in turn, affects a distance with its neighbouring parts. At critical platform configurations, the features of an arm actuator 50 can get close to the neighbouring features or a joint may reach to its end of range of motion. In such cases, only a range of offset rotation angles θ can prevent inter-collision within the motion system 10. By evaluating these ranges and distances throughout the workspace, optimized offset rotation angles θ can be determined that maximizes the minimum distances and remaining joint ranges (e.g., one of α and β may reach 0°).

In the present embodiment, the first and second rotation angles θo, θe are further adjusted (e.g., preset during assembly of the linear actuator arms 50) via respective kinematic constraints to maintain a minimum arm distance between the first linear arm actuator 50a, the second linear arm actuator 50b, and any other one of the linear arm actuators 50, depending on a range of configurations of the platform 30 with respect to the base 20. The “minimum arm distance” can be understood as a minimum distance to be maintained between any points of the linear arm actuators 50. The “range of configurations” of the platform 30 refers to foreseeable positions of the platform 30 throughout the workspace of the system 10.

Moreover, in the embodiment, first and second rotation angles θo, θe are further adjusted (e.g., preset during assembly of the linear actuator arms 50) via respective kinematic constraints to maintain a minimum base distance between the first linear arm actuator 50a, the second linear arm actuator 50b, and the base 20, depending on a range of configurations of the platform 30 with respect to the base 20. The “minimum base distance” can be understood as a minimum distance to be maintained between the base 20 and any point of the linear arm actuators 50 throughout the predicted workspace of the platform 30.

According to the embodiment, the first and second rotation angles θo, θe of the first and second actuator arms 50a, 50b are further adjusted via respective kinematic constraints to maintain a minimum joint distance between mating faces of any one of the top joint 60 and the bottom joint 70, depending on a position of the platform 30 with respect to the base 20.

In the embodiment shown, the rotation angle θo, θe of the first and second arm actuators 50a, 50b of each pair is fixed and preset, for example during assembly of the arms 50. In other words, as the angular position of a given arm actuator 50 changes as the platform 30 is moved, the imposed rotation angle θ does not change (i.e., fixed rotation angle). In fact, the rotation angle of each arm is preset during assembly by imposing the kinematic constraint, in this case on the (top) joint 60. According to the embodiment, and as previously mentioned, the rotation angles θo, θe of the first and second arm actuators 50a, 50b differ. In FIGS. 1 to 8, the rotation angles θo of the first arm actuator 50a (i.e., the “outer arm actuator”) and the second arm actuator 50b (i.e., the “inner arm actuator”) are respectively preset at 3.5° and 40°.

The preset and fixed rotation angles θo, θe around the joint-to-joint axes JJ′ have been selected to prevent inter-collision throughout the workspace of the system 10 and to maximize minimum distances (e.g., the minimum arm distance, the minimum base distance and the minimum joint distance covered above) between points, or at least between critical points that are considered fragile or sensitive in the platform system 10. By taking into account predetermined design parameters of the system, the person skilled in the art would understand to analyze and calculate the discussed minimum distances, for instance by discrete search throughout the workspace of the system 10, and therefrom the rotation angle θ of each cross-arranged linear actuator 50 of each pair is optimized. Likewise, other design parameters are optimized, including the wedge angle γ, again to prevent collisions.

According to an alternative embodiment, the preset rotation angle θ of the linear arm actuator 50 is not fixed to an angle. Instead, the kinematic constraints can allow a controlled range of rotational motions around the joint-to-joint axis that still meets the collision prevention conditions in the workspace. For example, the pivot joint 64 of the top joint 60 can be adapted to allow rotation θ of the linear arm actuator 50 between 39° and 41°.

In the previous description, non-limitative embodiments of the method are described. Although these embodiments of the assembly and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the method, as will be briefly explained herein and as can be easily inferred herefrom by a person skilled in the art. Moreover, it will be appreciated that positional descriptions such as “above”, “below”, “left”, “right”, “bottom”, “top”, “end” and the like should, unless otherwise indicated, be taken in the context of the figures and should not be considered limiting.

Furthermore, in the previous description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

In the present description, an embodiment is an example or embodiment. The various appearances of “one embodiment”, “one embodiment”, “an embodiment” or “some embodiments” do not necessarily all refer to the same embodiment or embodiment. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments or embodiment is included in at least some embodiments, but not necessarily all embodiments.

It is to be understood that the phraseology and terminology employed herein are not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included.

It will be appreciated that the methods described herein may be performed in the described order, or in any suitable order.

Several alternative embodiments, embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A motion platform system comprising:
a base; and
a platform movably supported on the base by a motion assembly, the motion assembly comprising a plurality of linear arm actuators, and at least one linear arm actuator of the plurality of linear arm actuators comprising:
an upper end coupled to the platform via a top joint,
a lower end coupled to the base via a bottom joint, thereby defining a joint-to-joint axis between the top joint and the bottom joint of the at least one linear arm actuator, and
a linear actuating portion provided between the upper end and the lower end, configured to reversibly extend along an axis of linear actuation to movably configure, at least partly, the platform relative to the base, and the at least one linear arm actuator being configured such that the axis of linear actuation is offset from the joint-to-joint axis; and
the at least one linear arm actuator having a rotation angle around the joint-to-joint axis, and wherein a kinematic chain thereof from the top joint to the bottom joint is configured to impose a kinematic constraint around the joint-to-joint axis, thereby adjusting the rotation angle of the at least one linear arm actuator.

2. The motion platform system of claim 1, wherein the at least one linear arm actuator is configured such that the axis of linear actuation intersects with the joint-to-joint axis at one of the top joint and the bottom joint.

3. The motion platform system of claim 1, wherein the at least one linear arm actuator is configured such that the axis of linear actuation and the joint-to-joint axis are non-intersecting with one another.

4. The motion platform system of claim 3, wherein the at least one arm linear actuator is further configured such that the axis of linear actuation and the joint-to-joint axis are parallel to one another.

5. The motion simulator system of claim 1, wherein the at least one linear arm actuator comprises a first linear arm actuator and a second linear arm actuator, the first and second linear arm actuators respectively having a first rotation angle around a first joint-to-joint axis and a second rotation angle around a second joint-to-joint axis, the first and second linear arm actuators being separately coupled to the platform and the base; and
wherein a respective kinematic chain of the first and second linear arm actuators is configured to impose a respective kinematic constraint around the first and second joint-to-joint axes, thereby adjusting the first and second rotation angles to allow a cross-arrangement of the first and second linear arm actuators.

6. The motion platform system of claim 5, wherein each first and second linear arm actuators further comprises a bracket portion interconnecting the linear actuating portion thereof and one of the top joint and the bottom joint, and wherein the linear actuating portion and the bracket portion define a free concave area therebetween; and wherein the first and second rotation angles of the first and second linear arm actuators are further adjusted via the respective kinematic constraints such that the free concave areas of the first and second linear arm actuators are adjacent to one another, thus allowing the cross-arrangement.

7. The motion platform system of claim 5, wherein the linear actuating portions of the first and second linear arm actuators respectively have a first outermost elbow portion and a second outermost elbow portion with respect to the first and second joint-to-joint axes; and wherein the first rotation angle is further adjusted via the respective kinematic constraint such that the first outermost elbow portion is positioned distantly from a central vertical axis of the base, and wherein the second rotation angle is adjusted via the respective kinematic constraint such that the second outermost elbow portion is positioned proximately to the central vertical axis of the base, thus allowing the cross-arrangement.

8. The motion platform system of claim 5, wherein the first and second rotation angles are preset via the respective kinematic constraints to maintain a minimum arm distance between the first linear arm actuator, the second linear arm actuator, and any other one of the plurality of linear arm actuators, depending on a range of configurations of the platform with respect to the base.

9. The motion platform system of claim 5, wherein the first and second rotation angles are preset via the respective kinematic constraints to maintain a minimum base distance between the first linear arm actuator, the second linear arm actuator, and the base, depending on a range of configurations of the platform with respect to the base.

10. The motion platform system of claim 5, wherein the first and second rotation angles are further adjusted via the respective kinematic constraints to maintain a minimum joint distance between mating faces of any one of the top joint and the bottom joint, depending on a range of configurations of the platform with respect to the base.

11. The motion platform system of claim 5, wherein the second rotation angle of the second linear arm actuator is greater than the first rotation angle of the first linear arm actuator.

12. The motion platform system of claim 5, wherein discrete platform connection points for the top joints of the plurality of linear arm actuators are concentrically distributed on a surface of the platform with respect to a central vertical axis of the platform; and wherein, when the motion assembly is not being actuated, a first platform connection point for a top joint of the first linear arm actuator is shifted on the platform surface by one platform connection point with respect to a vertical axis of a bottom joint of said first linear arm actuator, and wherein a second platform connection point for a top joint of the second linear arm actuator is vertically aligned with the bottom joint of the first linear arm actuator.

13. The motion platform system of claim 12, wherein the connection points of the top joints of the plurality of linear arm actuators are further radially equally distributed on the surface of the platform.

14. The motion platform system of claim 1, wherein discrete connection points for the bottom joints of the plurality of linear arm actuators are concentrically and radially equally distributed on a top surface of the base with respect to the central vertical axis of the base.

15. The motion platform system of claim 1, wherein the top joint and the bottom joint of the at least one linear arm actuator respectively comprise a universal joint and a spherical joint.

16. The motion platform system of claim 15, wherein the top joint of the at least one linear arm actuator further comprises an angled wedge interposing the universal joint thereof and the surface of the platform, and the angled wedge forming a wedge angle along a tangent direction with respect to a peripheral edge of the platform; and wherein a base of the spherical joint of the lower joint projecting from the upper surface of the base is tilted towards the central vertical axis of the base.

17. The motion simulator system of claim 1, wherein the plurality of linear actuators arms comprises at least eight linear arm actuators providing six degrees-of-freedom to the platform.

18. A motion platform system comprising:
a base; and
a platform movably supported on the base by a motion assembly, the motion assembly comprising a plurality of linear arm actuators, each one of the plurality of linear arm actuators comprising:
an upper end coupled to the platform via a top joint,
a lower end coupled to the base via a bottom joint, and
a linear actuating portion provided between the upper end and the lower end, configured to reversibly extend along an axis of linear actuation to movably configure, at least partly, the platform relative to the base, and the at least one linear arm actuator being configured such that the axis of linear actuation is offset from the joint-to-joint axis; and
wherein the plurality of linear arm actuators comprises first and linear second arm actuators respectively having a first rotation angle around a first joint-to-joint axis and a second rotation angle around a second joint-to-joint axis, the first and second linear arm actuators being separately coupled to the platform and the base, and wherein a respective kinematic chain of the first and second linear arm actuators from a corresponding top joint and bottom joint is configured to impose a respective kinematic constraint around the first and second joint-to-joint axes, thereby adjusting the first and second rotation angles to allow a cross-arrangement of the first and second arm actuators.

19. A linear arm actuator operably connectable to a platform and a base for a motion platform system, the linear arm actuator comprising:
a first end operably mounted with a first joint configured to couple one of the platform and the base of the motion platform system;
a second end operably mounted with a second joint configured to couple the other one of the platform and the base of the motion platform system, thereby defining a joint-to-joint axis between the first joint and the second joint;
a linear actuating portion provided between the first end and the second end, and configured to reversibly extend along an axis of linear actuation to space apart the first end and the second end, the linear arm actuator being configured such that the axis of linear actuation is offset from the joint-to-joint axis; and
at least one of the first and second joints being configurable to impose a kinematic constraint around the joint-to-joint axis to adjust a rotation angle of the linear arm actuator around the joint-to-joint axis.
